(19) United States
(12) Patent Application Publication
(10) Pub. No.: US 2010/0157296 A1
(43) Pub. Date: Jun. 24, 2010

(54) APPARATUS AND METHOD FOR DETERMINING THE TRANSPORT BEHAVIOUR IN THE PNEUMATIC TRANSPORT OF GRANULAR MATERIALS

(75) Inventors: Frank Stenger, Aizenau (DE); Alfons Karl, Gruendau (DE); Johann Mathias, Kahl (DE); Thomas Riedemann, Moembris (DE); Rudolf Scharffenberg-Kahlke, Euskirchen (DE); Karsten Aldenhoevel, Burgkirchen (DE)

Correspondence Address: SMITH, GAMBRELL & RUSSELL, 1130 CONNECTICUT AVENUE, N.W., SUITE 1130, WASHINGTON, DC, 20036, US

(73) Assignee: Evonik Degussa GmbH, Essen (DE)

(21) Appl. No.: 12/600,957

(22) PCT Filed: May 21, 2008
(86) PCT No.: PCT/EP2008/056243

§ 371 Date: Nov. 19, 2009

(30) Foreign Application Priority Data
Jun. 2, 2007 (DE) 102007025928.1

(51) Int. Cl. G01N 21/85; G01N 15/02; G01N 21/01; G01N 21/53

(52) U.S. Cl. 356/326; 356/244

(57) ABSTRACT

The invention relates to a method of determining the transport behaviour in the pneumatic transport of granular materials, in which
(A) the sample of granular material is introduced into a feed chute,
(B) the sample of granular material is, after the feed chute, introduced via an injector into a regulated stream of air,
(C) the sample of granular material flows through a transport section and
(D) the sample of granular material is measured in a laser light scattering spectrometer,
   wherein in step (B) the sample of granular material is introduced via a Venturi injector.

The apparatus for carrying out the method comprises
a feed chute for introduction of granular materials into the transport section,
a feed chute for introduction of unstressed granular materials into the laser light scattering spectrometer,
an air flow regulating valve,
a Venturi injector,
a transport section and
a laser light scattering spectrometer (4).

The invention relates to an apparatus and a method for determining the transport behaviour in the pneumatic transport of granular materials.

In the pneumatic transport of granular materials, fracture and abrasion of granules can occur [Pahl, M. H., Lagern, Fördern and Dosieren von Schüttgütern, Verlag TÜV Rheinland, Cologne, 1989, pp. 175-176].

It is known that the abrasion behaviour of granular materials can be determined by means of sieve stressing or measurement of the individual bead hardness [Ferch, H., Schriftenreihe Pigmente—Die Handhabung industriell erzeugter Ruβe, Degussa leaflets, Frankfurt, 1987, pp. 74-75].

These methods of determination have the disadvantage that they sometimes do not correlate well with results measured after pneumatic transport in production.

It is also known that the disintegration behaviour of particles in industrial processes, for example in a fluidized bed, can be simulated in a laboratory transport apparatus [Käferstein P., Mörl L., Dalichau J., Behns W., Appendix to the final report of the AiF project “Zerfallsverhalten von Partikeln in Wirbelschichten”, Research Project No. 11151 B, Magdeburg, 1999, pp. 17-21]. This apparatus comprises a compressed air supply unit, a solids metering unit, a transport section, a particle velocity measuring instrument, a laser light scattering spectrometer and an extraction and dust precipitation unit. Here, the sample of granular material to be measured is introduced by means of a vibrational conveyor into the funnel of an adjoining solids injector and thus into a stream of air having a defined volume flow. The granular material passes through the transport section and travels in perpendicular flow into the measurement section of the laser light scattering spectrometer. The stressed particle sample is precipitated in the downstream extraction and dust precipitation unit.

This known method of determination has the disadvantage that abrasion and fracture of the granular material is brought about on introduction of the granular material (solids injector), so that specific information on the transport behaviour in the pneumatic transport section can either not be obtained or is associated with errors. A further disadvantage of the known method is that an external measurement technique has to be employed to characterize an unstressed sample of granular material. However, a comparison of the particle size distribution of the unstressed and stressed samples forms the known basis for reliable information about the abrasion behaviour of granular materials during pneumatic transport.

It is an object of the invention to provide a method of determining the transport behaviour in the pneumatic transport of granular materials, in which destruction-free introduction of granular material is ensured. A further object of the invention is to provide an additional sample introduction and thus measurement point for characterizing the unstressed sample of granular material under comparable conditions.

The invention provides a method of determining the transport behaviour in the pneumatic transport of granular materials, in which
(A) the sample of granular material is introduced into a feed chute,
(B) the sample of granular material is, after the feed chute, introduced via an injector into a regulated stream of air,
(C) the sample of granular material flows through a transport section and
(D) the sample of granular material is measured in a laser light scattering spectrometer,
   characterized in that in step (B) the sample of granular material is introduced via a Venturi injector.

Here, the introduction of the sample into the Venturi injector can occur at the narrowest point of the injector.

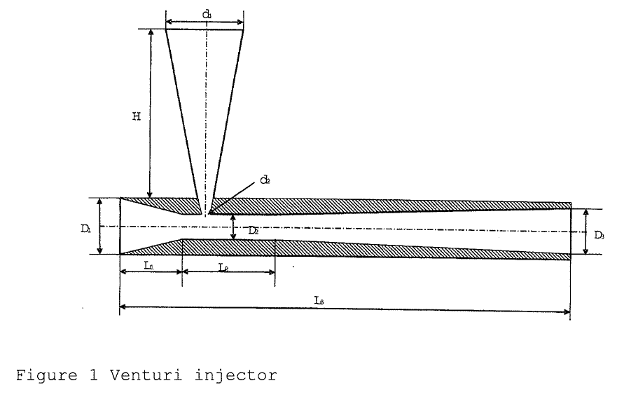

The Venturi injector can have a structure as shown in FIG. 1:
D₁ tube diameter of inlet,
D₂ tube diameter of Venturi,
D₃ tube diameter of outlet,
d₁ funnel diameter of inlet,
d₂ funnel diameter of outlet,
H funnel height,
L₁ length of inlet,
L₂ length of Venturi,
L₃ length of outlet.

Here, the tube diameters D₁ and D₃ can be in the range from 30 to 80 mm, preferably in the range from 40 to 50 mm, the tube diameter D₂ can be in the range from 10 to 30 mm, preferably from 18 to 23 mm. The ratio of D₂/D₁ or D₂/D₃ can vary in the range from 0.125 to 0.9, preferably from 0.36 to 0.55. The length of the inlet L₁ can be in the range from 30 to 80 mm, preferably from 40 to 60 mm, and the Venturi length L₂ can be in the range from 30 to 100 mm, preferably from 60 to 80 mm. The ratio L₁/L₂ can be in the range from 0.3 to 2.6, preferably from 0.5 to 1. The total length L₃ of the injector can be in the range from 110 to 1000 mm, preferably in the range from 220 to 440 mm. The diameter d₁ of the funnel can be in the range from 25 to 150 mm, preferably from 70 to 100 mm, and the diameter d₂ can be in the range from 5 to 20 mm, preferably from 8 to 15 mm. The ratio dᵢ/d₂ can be in the range from 1.25 to 30, preferably from 4.5 to 12.5. The height H of the funnel can be in the range from 50 to 200 mm, preferably from 100 to 150 mm.

The Venturi injector can be produced from shapable materials such as steels and plastics, for example stainless steel or Plexiglas. The external and internal surfaces of the injector can be treated, for example dressed or finely dressed.

The granular material can comprise pigments and fillers such as carbon blacks, for example furnace black, gas black, flame black or thermal black, channel black, plasma black, arc black, acetylene black, inversion black, known from DE 19521565, Si-containing carbon black, known from WO 98/45361 or DE 196113796, metal-containing carbon black, known from WO 98/42778, or carbon black containing heavy metals, as is obtained, for example, as by-product in synthesis gas production, titanium dioxides, silicas, for example precipitated or pyrogenic silicas, carbonates, borates, pelletized plastics, for example polymethyl methacrylate, polyesters, polyacrylates, polyamides or polyethers, and also composites and mixtures of the materials mentioned. The materials listed for the granular materials can have been after-treated or surface-modified, for example oxidized or coated.

Furthermore, the granular materials can have been wet, dry, oil or wax granulated. As granulation liquid, it is possible to use water, silanes or hydrocarbons, for example petroleum spirit or cyclohexane, with or without addition of binders, for example molasses, sugar, lignosulfonates and also numerous other materials either alone or in combination with one another.

The granular material can have a particle size in the range from 0.1 μm to 5 mm, preferably from 50 μm to 5 mm.

The transport section can have a diameter of from 30 to 60 mm, preferably from 40 to 50 mm, and a length in the range from 500 to 3000 mm. It is possible to use different tube geometries, for example bends, loops and impingement plates and also combinations thereof, as transport sections. The transport section can have been produced from shapable materials such as steels and plastics, for example stainless steel, Plexiglas or tubing materials such as polypropylene. The internal surfaces of the transport section can have been treated, for example dressed, polished, sand blasted or coated.

As carrier gas stream, it is possible to use various gases, preferably air. The carrier gas stream can be laden with various liquids, for example water. The carrier gas stream can be laden with amounts of from 0 to 20 g of liquid/kg of air.

The temperature of the carrier gas stream can vary in the range from 5 to 100° C., preferably from 20 to 40° C. The volume flows of the carrier gas can vary in the range from 5 to 600 m³/h, preferably from 10 to 400 m³/h.

The laser light scattering measuring instrument can be equipped with an optical lens system, a detector arrangement and a laser configuration so that particle size distributions in the size range from 0.1 μm to 5 mm can be detected. The scattering of the laser light results from interaction of the light with the particles and can be described mathematically by means of the Fraunhofer theory or the Mie theory. The intensity distribution of the light scattered by the particles is usually recorded by means of a multielement photodetector. To achieve optimal illumination of the particles by an even light wave, use is made of, for example, HeNe lasers having a wavelength of 632.8 nm provided with a long resonator and a spatial filter in the beam widening unit.

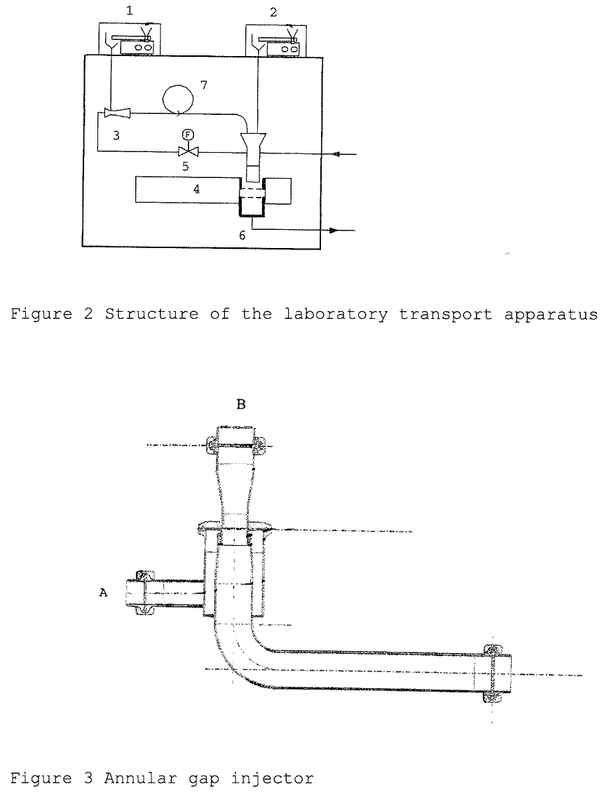

FIG. 2 shows the structure of a laboratory transport apparatus according to the invention:
1 vibrating chute stressing section,
2 vibrating chute reference measurement,
3 Venturi injector,
4 laser light scattering spectrometer,
5 air flow regulating valve,
6 exhaust air box,
7 stressing section.

The invention further provides an apparatus for determining the transport behaviour in the pneumatic transport of granular materials, which comprises
a feed chute (1) for introduction of granular materials into the transport section,
a feed chute (2) for introduction of unstressed granular materials into the laser light scattering spectrometer,
an air flow regulating valve (5),
a Venturi injector (3),
a transport section (7), for example a loop or bend, and
a laser light scattering spectrometer (4).

The apparatus can be connected to an exhaust air box. The apparatus can be surrounded by a noise protection box.

The method of the invention has the advantage that the introduction of the sample upstream of the transport section is destruction-free. The method of the invention has the further advantage that an unstressed sample of granular material can be characterized in the laser light scattering spectrometer.

### EXAMPLES

A Sympatec HELOS/KF-Magic laser light scattering spectrometer from Sympatec is used for the examples.

The Venturi injector used in the examples is made of stainless steel, the internal surfaces are finely dressed and it has the following dimensions: d₁=31 mm, d₂=11 mm, H=163 mm, D₁=44 mm, D₂=22 mm, D₃=44 mm, L₃=396 mm, L₁=55 mm, L₂=71 mm.

### Example 1

### Variation of the Injector Types

In the following example, a wet-granulated carbon black Purex HS 25 from Degussa GmbH having the properties shown in Table 1 is used.

TABLE 1

| Measurement | | | Method of |
|---|---|---|---|
| parameter | Measured value | | determination |
| CTAB | 28.2 | m²/g | ASTM 3765 |
| BET | 30.6 | m²/g | DIN 66131/2 |
| DBP | 123.5 | ml/100 g | DIN 53601 |
| Q3.10 | 290 | μm | ISO 133322-2 |
| Q3.50 | 849 | μm | ISO 133322-2 |
| Q3.90 | 1762 | μm | ISO 133322-2 |

15 g of a wet-granulated carbon black are in each case introduced into the transport section via the feed chute and different injectors (see FIGS. 3, 4 and 5 where A: air feed, B: granular material feed, C: tube). The velocity of the air in the transport tube (nominal diameter: 44 mm) is set to 14 m/s. The metering rate of the feed chute is selected so that a loading of 150 g of carbon black/kg of air is established in the transport gas stream. As transport section, use is made of a loop having a 360° turn and a subsequent bend as shown in FIG. 2. In the downstream laser light scattering spectrometer, the resulting intensity distributions are measured, evaluated and converted into a particle size distribution. The proportions by mass having particle sizes of <125 μm can be determined from the particle size distributions. The measured values shown in Table 2 are obtained.

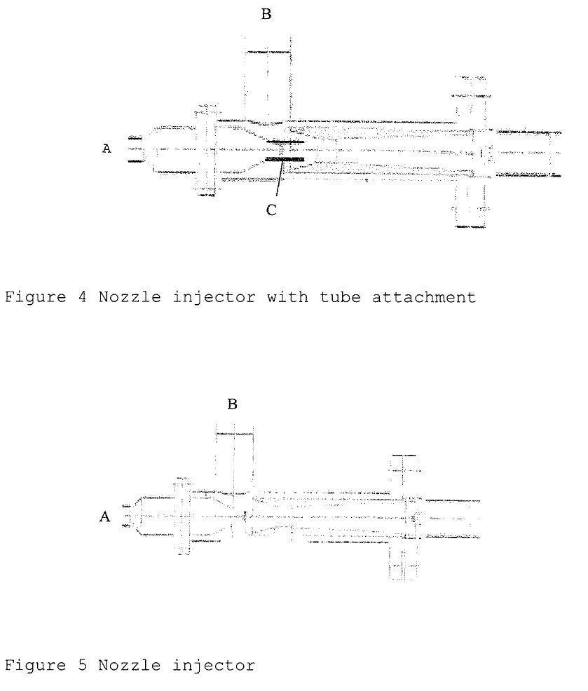

TABLE 2

| | Proportion by mass |
|---|---|
| Injector type | <125 μm |
| Annular gap injector as shown in | 79.8% |
| FIG. 3 | |
| Nozzle + tube as shown in FIG. 4 | 48.1% |
| Nozzle, 10.5 mm as shown in FIG. 5 | 41.2% |
| Venturi injector as shown in | 37.0% |
| FIG. 1 | |

The proportion by mass of granules having a size of <125 μm serves as a measure of the destruction of the granules. Assuming equal stressing of the samples in the stressing section, this parameter is at the same time a measure of the stressing of the samples in the injector. The Venturi injector displays the lowest destruction of granules during introduction of the sample.

### Example 2

### Reproducibility of the Measurements

In the following example, a wet-granulated carbon black Purex HS 25 from Degussa GmbH having the properties shown in Table 3 is used.

TABLE 3

| Measurement | | | Method of |
|---|---|---|---|
| parameter | Measured value | | determination |
| CTAB | 28.2 | m²/g | ASTM 3765 |
| BET | 30.6 | m²/g | DIN 66131/2 |
| DBP | 123.5 | ml/100 g | DIN 53601 |
| Q3.10 | 290 | μm | ISO 133322-2 |
| Q3.50 | 849 | μm | ISO 133322-2 |
| Q3.90 | 1762 | μm | ISO 133322-2 |

15 g of the carbon black are in each case introduced into the transport section via the feed chute and the Venturi injector. The velocity of air in the transport tube (nominal diameter: 44 mm) is set to 10, 12, 14 and 16 m/s. The metering rate of the feed chute is selected so that a loading of 27 g of carbon black/kg of air is established. As transport section, use is made of a loop having a 360° turn and a subsequent bend as shown in FIG. 2. The proportions by mass having particle sizes of <125 μm are determined from the particle size distributions in the downstream laser light scattering spectrometer. Each measurement is repeated three times and the standard deviation is calculated according to the following formula:

$$σ = \sqrt{\frac{n ( \sum {x}^{2} ) - {( \sum x )}^{2}}{n ( n - 1 )}} .$$

The results shown in Table 4 are obtained.

TABLE 4

| | Proportion | Standard |
|---|---|---|
| Velocity of air | by mass <125 μm | deviation σ |
| 10 m/s | 14.8% | |
| | 14.1% | |
| | 16.0% | 0.96 |
| 12 m/s | 24.7% | |
| | 25.0% | |
| | 25.6% | 0.46 |
| 14 m/s | 36.3% | |
| | 37.0% | |
| | 37.1% | 0.44 |
| 16 m/s | 50.9% | |
| | 50.5% | |
| | 50.6% | 0.21 |

The Venturi injector displays a very good reproducibility.

### Example 3

### Use of Differently Granulated Types of Carbon Black

Four differently granulated types of carbon black from Degussa GmbH having the properties shown in Table 5 are used in the following example.

TABLE 5

| | Type of carbon | | | |
|---|---|---|---|---|
| | black | | | |
| | 1 | 2 | 3 | |
| | Printex | Printex | Printex | 4 |
| | Alpha | Alpha A | ES 34 | Purex HS 25 |
| CTAB [m²/g] | 77.4 | 83.7 | | 28.2 |
| BET [m²/g] | 97.8 | 103.9 | | 30.6 |
| DBP [ml/100 g] | 97.8 | 99 | 74.6 | 123.5 |
| Q3.10 [μm] | 157 | 196 | 163 | 290 |
| Q3.50 [μm] | 335 | 579 | 375 | 849 |
| Q3.90 [μm] | 655 | 949 | 1494 | 1762 |
| Granulation | dry | wet | oil | wet with |
| | | | | granulation |
| | | | | aid |

15 g of the respective type of carbon black are introduced via the feed chute into the measurement section of the laser light scattering spectrometer and the particle size distribution of the unstressed sample of granular material is determined.

15 g of the respective type of carbon black are introduced into the transport section via the feed chute and the Venturi injector. The velocity of air in the transport tube (nominal diameter: 44 mm) is set to 13 m/s. The metering rate of the feed chute is selected so that a loading of 27 g of carbon black/kg of air is established. As transport section, use is made of a loop having a 360° turn and a subsequent bend as shown in FIG. 2. In the downstream laser light scattering spectrometer, the proportions by mass of the stressed sample of granular material having particle sizes of <125 μm are determined from the particle size distributions. The Δproportion by mass <125 μm is given by the difference between the proportions by mass for the stressed sample and the unstressed sample. The measured values are shown in Table 6.

TABLE 6

| Type | | |
|---|---|---|
| of | Proportion by mass | |
| carbon | <125 μm (stressed | Δ proportion by mass |
| black | sample) | <125 μm |
| 1 | 78.7% | 12.8% |
| 2 | 65.7% | 1.9% |
| 3 | 46.4% | 7.4% |
| 4 | 30.0% | 1.2% |

As can be seen from Table 6, different granulation processes can be differentiated by means of the measurement technique claimed.

### Example 4

### Characterization of Pyrogenic Silica

In the following example, a predensified pyrogenic silica Aerosil 200 from Degussa GmbH having the properties shown in Table 7 is used.

TABLE 7

| Measurement | | | Method of |
|---|---|---|---|
| parameter | Measured value | | determination |
| BET | 200 | m²/g | DIN 66131/2 |
| Q3.10 | 615.4 | μm | ISO 133322-2 |
| Q3.50 | 1521.2 | μm | ISO 133322-2 |
| Q3.90 | 2848.7 | μm | ISO 133322-2 |

10 g of the silica described are introduced via the feed chute into the measurement section of the laser light scattering spectrometer and the particle size distribution of the unstressed sample of granular material is determined.

10 g of the granular silica described are introduced into the transport section via the feed chute and the Venturi injector. The velocity of air in the transport tube (nominal diameter: 44 mm) is set in the range from 11 to 15 m/s. The metering rate of the feed chute is selected so that a loading of 27 g of silica/kg of air is established. As transport section, use is made of a loop having a 360° turn and a subsequent bend as shown in FIG. 2. In the downstream laser light scattering spectrometer, the proportions by mass of the stressed sample of granular material having particle sizes of <125 μm are determined from the particle size distributions. The Δ proportion by mass <125 μm is given by the difference between the proportions by mass for the stressed sample and the unstressed sample. The values shown in Table 8 are obtained. The unstressed sample has a proportion by mass <125 μm of 0%.

TABLE 8

| | Proportion by mass | |
|---|---|---|
| Velocity | <125 μm | Δ Proportion by mass |
| of air | (stressed sample) | <125 μm |
| 0 m/s | 0% | 0% |
| 11 m/s | 2.8% | 2.8% |
| 13 m/s | 4.8% | 4.8% |
| 15 m/s | 7.8% | 7.8% |

As can be seen from the example described, the destruction of the granules of predensified pyrogenic silicas at various velocities of air can also be characterized very well.

1. Method of determining the transport behaviour in the pneumatic transport of granular materials, in which
(A) the sample of granular material is introduced into a feed chute,
(B) the sample of granular material is, after the feed chute, introduced via an injector into a regulated stream of air,
(C) the sample of granular material flows through a transport section and
(D) the sample of granular material is measured in a laser light scattering spectrometer,
characterized in that in step (B) the sample of granular material is introduced via a Venturi injector.

2. Apparatus for carrying out the method according to claim 1, comprising
a feed chute (1) for introduction of granular materials into the transport section,
a feed chute (2) for introduction of unstressed granular materials into the laser light scattering spectrometer,
an air flow regulating valve (5),
a Venturi injector (3),
a transport section (7) and
a laser light scattering spectrometer (4).
